(19) United States
(12) Patent Application Publication
(10) Pub. No.: US 2025/0164705 A1
(43) Pub. Date: May 22, 2025

(54) OPTICAL CONNECTOR

(71) Applicant: ADVANTEST Corporation, Tokyo (JP)

(72) Inventors: Hideo HARA, Miyagi (JP); Kengo SUZUKI, Saitama (JP)

(73) Assignee: ADVANTEST Corporation, Tokyo (JP)

(21) Appl. No.: 18/898,950

(22) Filed: Sep. 27, 2024

(30) Foreign Application Priority Data
Nov. 16, 2023 (JP) 2023-194914

(51) Int. Cl. G02B 6/38

(52) U.S. Cl. CPC G02B 6/3886

(57) ABSTRACT

An optical connector includes one ferrule and a ferrule position retaining portion. The ferrule position retaining portion holds the one ferrule at a predetermined position. The predetermined position is a position of the one ferrule at which the one ferrule is connected with an other ferrule. The ferrule position retaining portion is arranged to hold the one ferrule such that the one ferrule is movable before and after the one ferrule is connected with the other ferrule.

### BACKGROUND OF THE INVENTION

### Field of the Invention

The present invention relates to preventing a guide hole of a ferrule from being scraped.

### Description of the Related Art

There have conventionally been known some ferrule types (see WO2022/074866, Japanese Patent Application Publication No. 2009-145725, WO2022/029930, and Japanese Patent Application Publication No. 2021-101254, for example) and, among them, an MT ferrule standard is well known, which is one of the standards that allow for connection of small-sized multi-channel optical fibers. In accordance with the MT ferrule standard, a guide pin that is mounted to one MT ferrule can be inserted thorough a guide hole of the other MT ferrule to provide connection between optical fibers. An MT ferrule, which can be used by itself, is stored and used inside an optical connector (e.g. MPO connector or backplane connector).

An optical connector may be used for a guide pin and a guide hole to be positioned with respect to each other for fitting. However, even if the optical connector may be used, the guide pin and the guide hole cannot always be positioned for proper fitting due to, for example, an error in the optical connector. Hence, an MT ferrule is floated by, for example, a spring, and further the guide pin is tapered so as to be drawn into the guide hole.

It is noted that since the guide pin is made of, for example, stainless steel and the MT ferrule is made of, for example, polyphenylene sulfide (PPS) resin, the guide pin is harder than the MT ferrule. Since the guide hole is provided in the MT ferrule, the guide pin is harder than the edge of the guide hole.

### SUMMARY OF THE INVENTION

However, when a guide pin is drawn into a guide hole as in the above-described related art, the guide pin may encounter and scrape the edge of the guide hole. Particularly, the guide pin, when successively encounters the same part of the edge of the guide hole, may easily scrape the edge of the guide hole.

In a case where the edge of the guide hole is scraped, the guide hole may be widened, and the positional relationship between optical fibers that are connected to each other may be deviated from the optimum, resulting in an increase in the coupling loss. Shavings after the guide hole is scraped may scatter and adhere to the end face of the optical fiber, also resulting in an increase in the coupling loss.

It is hence an object of the present invention to inhibit the edge of a guide hole of a ferrule from being scraped by a guide pin.

According to a first aspect of the present invention, an optical connector, includes: one ferrule; and a ferrule position retaining portion that holds the one ferrule at a predetermined position, wherein the predetermined position is a position of the one ferrule at which the one ferrule is connected with an other ferrule, and the ferrule position retaining portion is arranged to hold the one ferrule such that the one ferrule is movable before and after the one ferrule is connected with the other ferrule.

According to the thus constructed optical connector includes: one ferrule; and a ferrule position retaining portion. The ferrule position retaining portion holds the one ferrule at a predetermined position. The predetermined position is a position of the one ferrule at which the one ferrule is connected with an other ferrule. The ferrule position retaining portion is arranged to hold the one ferrule such that the one ferrule is movable before and after the one ferrule is connected with the other ferrule.

According to the optical connector of the first aspect of the present invention, the ferrule position retaining portion may have: a magnetic body that is attached to the one ferrule; and a magnet that is arranged in a manner opposed to the magnetic body.

According to the first aspect of the present invention, the optical connector may further include a ferrule housing portion that houses the one ferrule therein, wherein the magnet may be attached to the ferrule housing portion.

According to the optical connector of the first aspect of the present invention, the magnet may be arranged farther from the other ferrule than the magnetic body.

According to the optical connector of the first aspect of the present invention, the magnet may be arranged closer to the other ferrule than the magnetic body.

According to a second aspect of the present invention, an optical connector, includes: one ferrule; and a ferrule position retaining portion that holds the one ferrule at a predetermined position, wherein the ferrule position retaining portion has: a first magnet that is attached to the one ferrule; and a second magnet that is arranged in a manner opposed to the first magnet, the predetermined position is a position of the one ferrule before the one ferrule is connected with an other ferrule, and the ferrule position retaining portion is arranged to hold the one ferrule such that the one ferrule is movable before and after the one ferrule is connected with the other ferrule.

According to the thus constructed optical connector, includes: one ferrule; and a ferrule position retaining portion. The ferrule position retaining portion holds the one ferrule at a predetermined position. The ferrule position retaining portion has: a first magnet that is attached to the one ferrule; and a second magnet that is arranged in a manner opposed to the first magnet. The predetermined position is a position of the one ferrule before the one ferrule is connected with an other ferrule. The ferrule position retaining portion is arranged to hold the one ferrule such that the one ferrule is movable before and after the one ferrule is connected with the other ferrule.

According to the second aspect of the present invention, the optical connector may further include a ferrule housing portion that houses the one ferrule therein, wherein the second magnet is attached to the ferrule housing portion.

According to the optical connector of the second aspect of the present invention, the second magnet may be arranged farther from the other ferrule than the first magnet.

According to the optical connector of the second aspect of the present invention, the second magnet may be arranged closer to the other ferrule than the first magnet.

According to the optical connector of the second aspect of the present invention, the one ferrule may have a guide hole, and the other ferrule may have a guide pin to be inserted into the guide hole.

According to the optical connector of the second aspect of the present invention, the other ferrule may have a guide hole, and the one ferrule may have a guide pin to be inserted into the guide hole.

According to the optical connector of the second aspect of the present invention, the other ferrule may be pressed by a pressing member toward the one ferrule.

According to the second aspect of the present invention, the optical connector may further include a pressing member that presses the one ferrule toward the other ferrule.

### BRIEF DESCRIPTION OF THE DRAWINGS

FIGS. 1(a), 1(b), 1(c) and 1(d) include planar cross-sectional views showing one optical connector 1 according to a first embodiment of the present invention before the other optical connector 2 is inserted (FIG. 1(a)), immediately before the other optical connector 2 is inserted (FIG. 1(b)), when the other optical connector 2 is fitted (FIG. 1(c)), and when the other optical connector 2 is removed (FIG. 1(d));

FIG. 2 is a planar cross-sectional view of one optical connector 1 according to a first variation of the first embodiment;

FIG. 3 is a planar cross-sectional view of one optical connector 1 according to a second variation of the first embodiment;

FIGS. 4(a), 4(b), 4(c) and 4(d) include planar cross-sectional views showing the one optical connector 1 according to a second embodiment of the present invention before the other optical connector 2 is inserted (FIG. 4(a)), immediately before the other optical connector 2 is inserted (FIG. 4(b)), when the other optical connector 2 is fitted (FIG. 4(c)), and when the other optical connector 2 is removed (FIG. 4(d));

FIG. 5 is a planar cross-sectional view of one optical connector 1 according to a first variation of the second embodiment;

FIG. 6 is a planar cross-sectional view of one optical connector 1 according to a second variation of the second embodiment; and

FIG. 7 is a planar cross-sectional view of one optical connector 1 according to a third variation of the second embodiment.

### DESCRIPTION OF THE PREFERRED EMBODIMENTS

Preferred embodiments of the present invention will hereinafter be described with reference to the accompanying drawings.

### First Embodiment

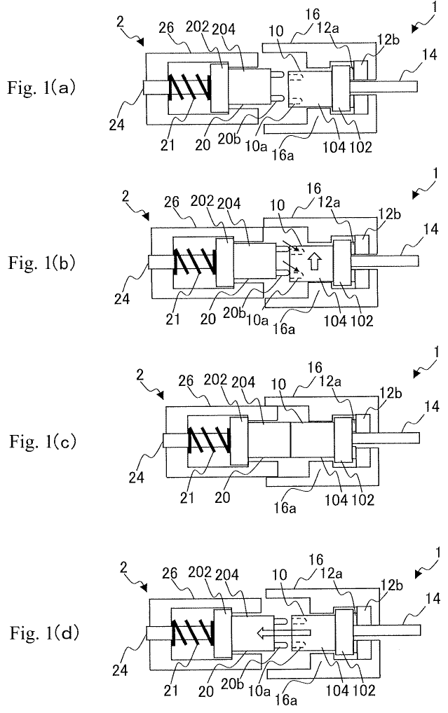

FIG. 1 includes planar cross-sectional views showing one optical connector 1 according to a first embodiment of the present invention before the other optical connector 2 is inserted (FIG. 1(a)), immediately before the other optical connector 2 is inserted (FIG. 1(b)), when the other optical connector 2 is fitted (FIG. 1(c)), and when the other optical connector 2 is removed (FIG. 1(d)).

The one optical connector 1 includes one ferrule 10, a ferrule position retaining portion (a magnetic body 12a and a magnet 12b), one optical fiber 14, and one ferrule housing portion 16.

The one ferrule 10 is a well-known MT ferrule. The one ferrule 10 has a guide hole 10a. The one ferrule 10 has a base 102 and a projection 104. The base 102 is wider than the projection 104 and is arranged farther from the other ferrule 20 than the projection 104.

The one optical fiber 14 is connected to the one ferrule 10. The one ferrule housing portion 16 houses the one ferrule 10 therein. The one ferrule housing portion 16 has a protruding portion 16a. The protruding portion 16a protrudes inward from the one ferrule housing portion 16. The protruding portion 16a is opposed to the base 102. The base 102, when moves toward the other ferrule 20, encounters the protruding portion 16a. This prevents the one ferrule 10 from falling off the one ferrule housing portion 16.

The ferrule position retaining portion (magnetic body 12a and magnet 12b) holds the one ferrule 10 at a predetermined position. Note here that the predetermined position in the first embodiment is a position of the one ferrule 10 with the one ferrule 10 connected with the other ferrule 20 (see FIG. 1(c)).

Note further that the ferrule position retaining portion is arranged to hold the one ferrule 10 such that the one ferrule 10 is movable before and after the one ferrule 10 is connected with the other ferrule 20 (see FIGS. 1(a) and 1(c)). For example, the ferrule position retaining portion is arranged to hold the one ferrule 10 such that the one ferrule 10 is movable vertically in FIG. 1.

The ferrule position retaining portion has the magnetic body 12a and the magnet 12b. The magnetic body 12a is attached to the base 102 of the one ferrule 10. The magnet 12b is arranged in a manner opposed to the magnetic body 12a. The magnetic body 12a adheres to the magnet 12b while slidable vertically in FIG. 1 on the surface of the magnet 12b.

The magnet 12b is attached to the ferrule housing portion 16. The magnet 12b is arranged farther from the other ferrule 20 than the magnetic body 12a. It is noted that the magnet 12b is attached to approximately the entire surface inside the ferrule housing portion 16 that is opposed to the base 102.

The other optical connector 2 includes the other ferrule 20, a spring (pressing member) 21, the other optical fiber 24, and the other ferrule housing portion 26.

The other ferrule 20 is a well-known MT ferrule. The other ferrule 20 has a guide pin 20b. The guide pin 20b is arranged to be inserted into the guide hole 10a. The other ferrule 20 has a base 202 and a projection 204. The base 202 is wider than the projection 204 and is arranged farther from the one ferrule 10 than the projection 204.

It is noted that the guide pin 20b is chamfered or R-chamfered. This causes the guide pin 20b to have a feature (draw-in feature) with which misalignment between the one ferrule 10 and the other ferrule 20 can be absorbed during insertion into the guide hole 10a. The amount of sliding of the one ferrule 10 falls within the range of draw-in of the guide pin 20b.

The other optical fiber 24 is connected to the other ferrule 20. The other ferrule housing portion 26 houses the other ferrule 20 therein.

The spring (pressing member) 21 presses the other ferrule 20 toward the one ferrule 10.

Next will be described an operation according to the first embodiment.

First, with reference to FIG. 1(a), the other ferrule 20 and the one ferrule 10 are misaligned with each other before the other optical connector 2 is inserted into the one optical connector 1.

Next, with reference to FIG. 1(b), the guide pin 20b of the other ferrule 20 is drawn into the guide hole 10a of the one ferrule 10 in the direction indicated by the arrows (rightward and downward) and the one ferrule 10 moves in the direction indicated by the open arrow (upward) immediately before the other optical connector 2 is inserted into the one optical connector 1. It is noted that the magnetic body 12a adheres to the magnet 12b while slidable on the surface of the magnet 12b, and therefore the one ferrule 10 (to which the magnetic body 12a is attached) is also movable. It is noted that the position of the other ferrule 20, which is pressed by the spring 21, cannot change.

After the misalignment between the other ferrule 20 and the one ferrule 10 is thus eliminated, the guide pin 20b of the other ferrule 20 is fitted into the guide hole 10a of the one ferrule 10 for connection between the one ferrule 10 and the other ferrule 20 as shown in FIG. 1(c). The position of the one ferrule 10 upon this is the “predetermined position” in the first embodiment.

Finally, with reference to FIG. 1(d), even after the other ferrule 20 is removed from the one ferrule 10, the magnetic body 12a that is attached to the one ferrule 10 adheres to the magnet 12b and therefore the one ferrule 10 is continuously held at the predetermined position (see FIG. 1(c)). It is noted that the adherence between the magnetic body 12a and the magnet 12b should be weaker than the force required to remove the other ferrule 20 from the one ferrule 10.

In accordance with the first embodiment, when the other ferrule 20 once removed is connected again to the one ferrule 10, the guide pin 20b of the other ferrule 20 and the guide hole 10a of the one ferrule 10 hardly undergo misalignment because the one ferrule 10 is held at the predetermined position (see FIG. 1(c)). For this reason, the edge of the guide hole 10a is hardly scraped by the guide pin 20b (with no need for draw-in). This can inhibit the edge of the guide hole 10a of the one ferrule 10 from being scraped by the guide pin 20b.

It is noted that the first embodiment is effective when optical connectors of the same set are connected many times. For example, the first embodiment can be applied effectively to optical connection between an optical probe card and a test head.

It is noted that the first embodiment may include the following variations.

### <First Variation>

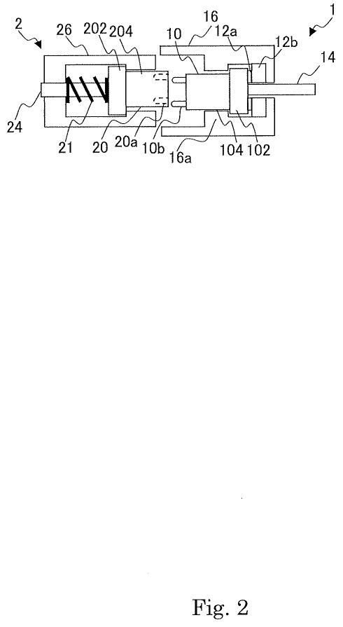

FIG. 2 is a planar cross-sectional view of one optical connector 1 according to a first variation of the first embodiment. In contrast to the first embodiment, the other ferrule 20 has a guide hole 20a and the one ferrule 10 has a guide pin 10b in the first variation of the first embodiment. Note here that the guide pin 10b is arranged to be inserted into the guide hole 20a.

### <Second Variation>

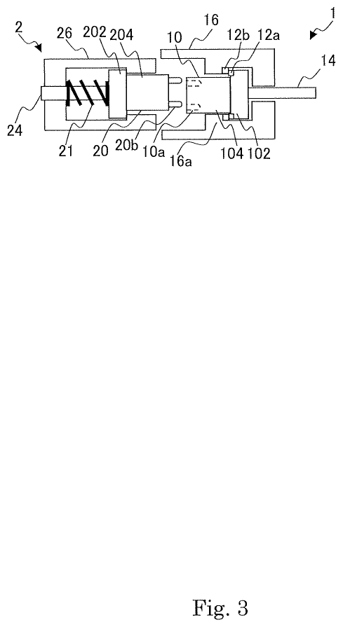

FIG. 3 is a planar cross-sectional view of one optical connector 1 according to a second variation of the first embodiment. In the second variation of the first embodiment, the magnet 12b is arranged closer to the other ferrule 20 than the magnetic body 12a. Specifically, the magnet 12b is arranged on the protruding portion 16a and the magnetic body 12a is opposed to the magnet 12b.

### Second Embodiment

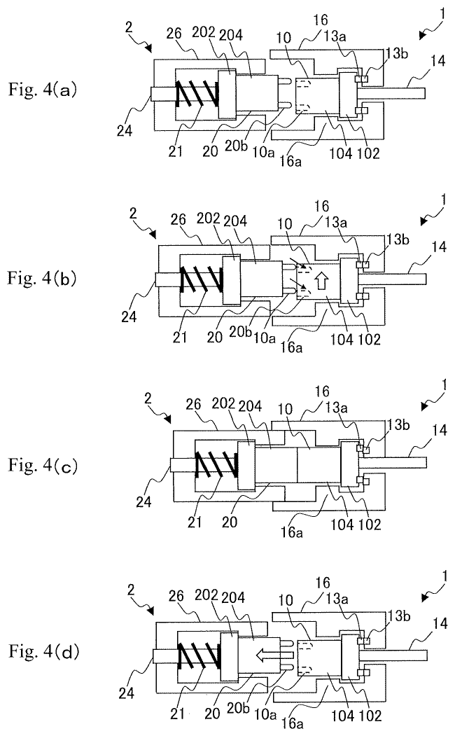

The second embodiment differs from the first embodiment in that the ferrule position retaining portion includes a first magnet 13a and a second magnet 13b. The second embodiment further differs from the first embodiment in that the predetermined position is a position of the one ferrule 10 before the one ferrule 10 is connected with the other ferrule 20 (see FIG. 4(a)).

FIG. 4 includes planar cross-sectional views showing the one optical connector 1 according to the second embodiment of the present invention before the other optical connector 2 is inserted (FIG. 4(a)), immediately before the other optical connector 2 is inserted (FIG. 4(b)), when the other optical connector 2 is fitted (FIG. 4(c)), and when the other optical connector 2 is removed (FIG. 4(d)). Components identical to those in the first embodiment will hereinafter be designated by the same reference numerals to omit the descriptions thereof.

The one optical connector 1 includes one ferrule 10, a ferrule position retaining portion (a first magnet 13a and a second magnet 13b), one optical fiber 14, and one ferrule housing portion 16.

The one ferrule 10, the one optical fiber 14, and the one ferrule housing portion 16 are the same as those in the first embodiment and will not be described.

The ferrule position retaining portion (first magnet 13a and second magnet 13b) holds the one ferrule 10 at a predetermined position. Note here that the predetermined position in the second embodiment is a position of the one ferrule 10 before the one ferrule 10 is connected with the other ferrule 20 (see FIG. 4(a)).

Note further that the ferrule position retaining portion is arranged to hold the one ferrule 10 such that the one ferrule 10 is movable before and after the one ferrule 10 is connected with the other ferrule 20 (see FIGS. 4(a) and 4(c)). For example, the ferrule position retaining portion is arranged to hold the one ferrule 10 such that the one ferrule 10 is movable vertically in FIG. 4.

The ferrule position retaining portion has the first magnet 13a and the second magnet 13b. The first magnet 13a is attached to the base 102 of the one ferrule 10. The second magnet 13b is arranged in a manner opposed to the first magnet 13a. The first magnet 13a and the second magnet 13b adhere to each other while the first magnet 13a is slidable vertically in FIG. 4 on the surface of the second magnet 13b.

The second magnet 13b is attached to the ferrule housing portion 16. The second magnet 13b is arranged farther from the other ferrule 20 than the first magnet 13a. It is noted that the second magnet 13b is attached to a central portion of the surface inside the ferrule housing portion 16 that is opposed to the base 102 (also in the vicinity of the one optical fiber 14).

The other optical connector 2 is the same as that in the first embodiment and will not be described.

Next will be described an operation according to the second embodiment.

First, with reference to FIG. 4(a), the other ferrule 20 and the one ferrule 10 are misaligned with each other before the other optical connector 2 is inserted into the one optical connector 1. The position of the one ferrule 10 upon this (i.e. before the one ferrule 10 is connected with the other ferrule 20) is the “predetermined position” (in other words, home position) in the second embodiment.

Next, with reference to FIG. 4(b), the guide pin 20b of the other ferrule 20 is drawn into the guide hole 10a of the one ferrule 10 in the direction indicated by the arrows (rightward and downward) and the one ferrule 10 moves in the direction indicated by the open arrow (upward) immediately before the other optical connector 2 is inserted into the one optical connector 1. It is noted that the first magnet 13a and the second magnet 13b adhere to each other while the first magnet 13a is slidable on the surface of the second magnet 13b, and therefore the one ferrule 10 (to which the first magnet 13a is attached) is also movable. It is noted that the force for sliding in the vertical direction in FIG. 4 is weaker than the adherence between the first magnet 13a and the second magnet 13b.

After the misalignment between the other ferrule 20 and the one ferrule 10 is thus eliminated, the guide pin 20b of the other ferrule 20 is fitted into the guide hole 10a of the one ferrule 10 for connection between the one ferrule 10 and the other ferrule 20 as shown in FIG. 4(c). Upon this, the first magnet 13a and the second magnet 13b remain misaligned with each other.

Finally, with reference to FIG. 4(d), after the other ferrule 20 is removed from the one ferrule 10, since the first magnet 13a adheres to the second magnet 13b, the one ferrule 10 is returned to the predetermined position and continuously held there (see FIG. 4(a)). It should be noted that since the second magnet 13b is arranged in a central portion of the surface inside the ferrule housing portion 16 that is opposed to the base 102, the one ferrule 10 is also returned to approximately the center inside the ferrule housing portion 16 (see FIG. 4(a)).

In accordance with the second embodiment, even in a case where the other ferrules 20 of various types may be connected in turns to the one ferrule 10, the guide pin 20b of the other ferrule 20 and the guide hole 10a of the one ferrule 10 undergo reduced misalignment because the one ferrule 10 is held at the predetermined position (see FIG. 4(a)) (approximately the center inside the ferrule housing portion 16). For this reason, the edge of the guide hole 10a is less likely to be scraped by the guide pin 20b. This can inhibit the edge of the guide hole 10a of the one ferrule 10 from being scraped by the guide pin 20b.

It is noted that the second embodiment is effective when the other ferrule 20 does not always have a fixed position. For example, the second embodiment can be applied effectively when a DUT (device under test) having an optical interface (optical connector) is measured.

It is noted that the second embodiment may include the following variations.

### <First Variation>

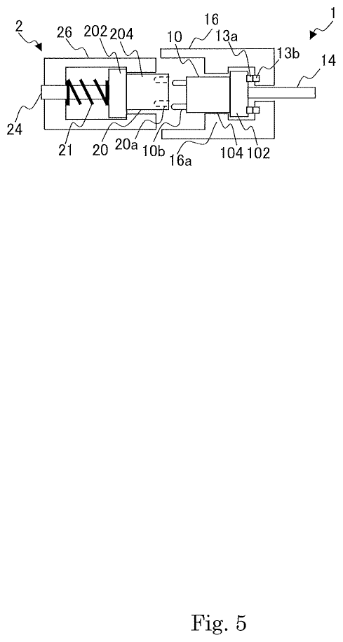

FIG. 5 is a planar cross-sectional view of one optical connector 1 according to a first variation of the second embodiment. In contrast to the second embodiment, the other ferrule 20 has a guide hole 20a and the one ferrule 10 has a guide pin 10b in the first variation of the second embodiment. Note here that the guide pin 10b is arranged to be inserted into the guide hole 20a.

### <Second Variation>

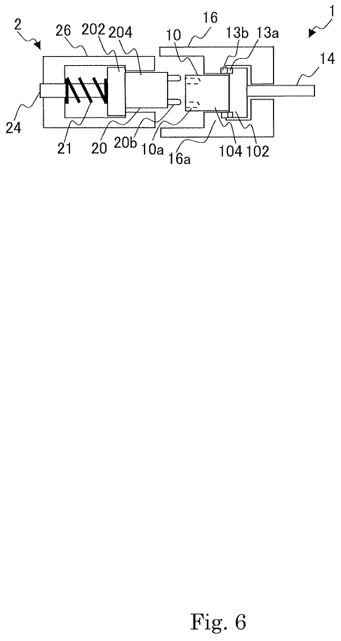

FIG. 6 is a planar cross-sectional view of one optical connector 1 according to a second variation of the second embodiment. In the second variation of the second embodiment, the second magnet 13b is arranged closer to the other ferrule 20 than the first magnet 13a. Specifically, the second magnet 13b is arranged on the protruding portion 16a and the first magnet 13a is opposed to the second magnet 13b.

### <Third Variation>

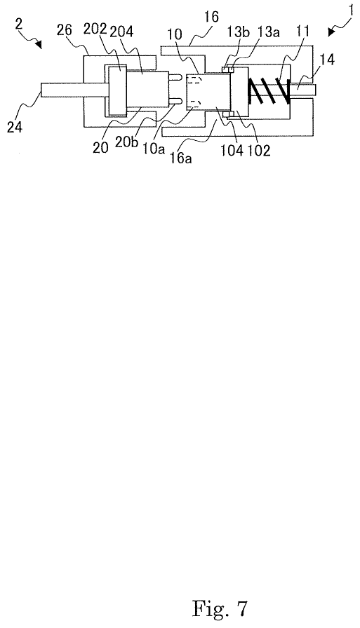

FIG. 7 is a planar cross-sectional view of one optical connector 1 according to a third variation of the second embodiment. The one optical connector 1 according to the third variation of the second embodiment includes a spring (pressing member) 11. The spring 11 presses the one ferrule 10 toward the other ferrule 20. Note here that in the third variation of the second embodiment, the first magnet 13a and the second magnet 13b have the same arrangement as that in the second variation of the second embodiment.

### DESCRIPTION OF REFERENCE NUMERALS

1 One Optical Connector
10 One Ferrule
11 Spring (Pressing Member)
12a Magnetic Body
12b Magnet
13a First Magnet
13b Second Magnet
14 One Optical Fiber
16 One Ferrule Housing Portion
2 Other Optical Connector
20 Other Ferrule
21 Spring (Pressing Member)
24 Other Optical Fiber
26 Other Ferrule Housing Portion

What is claimed is:

1. An optical connector, comprising:
one ferrule; and
a ferrule position retaining portion that holds the one ferrule at a predetermined position, wherein
the predetermined position is a position of the one ferrule at which the one ferrule is connected with an other ferrule, and
the ferrule position retaining portion is arranged to hold the one ferrule such that the one ferrule is movable before and after the one ferrule is connected with the other ferrule.

2. The optical connector according to claim 1, wherein
the ferrule position retaining portion has:
a magnetic body that is attached to the one ferrule; and
a magnet that is arranged in a manner opposed to the magnetic body.

3. The optical connector according to claim 2, further comprising a ferrule housing portion that houses the one ferrule therein, wherein
the magnet is attached to the ferrule housing portion.

4. The optical connector according to claim 3, wherein
the magnet is arranged farther from the other ferrule than the magnetic body.

5. The optical connector according to claim 3, wherein
the magnet is arranged closer to the other ferrule than the magnetic body.

6. An optical connector, comprising:
one ferrule; and
a ferrule position retaining portion that holds the one ferrule at a predetermined position, wherein
the ferrule position retaining portion has:
a first magnet that is attached to the one ferrule; and
a second magnet that is arranged in a manner opposed to the first magnet,
the predetermined position is a position of the one ferrule before the one ferrule is connected with an other ferrule, and
the ferrule position retaining portion is arranged to hold the one ferrule such that the one ferrule is movable before and after the one ferrule is connected with the other ferrule.

7. The optical connector according to claim 6, further comprising a ferrule housing portion that houses the one ferrule therein, wherein
the second magnet is attached to the ferrule housing portion.

8. The optical connector according to claim 7, wherein
the second magnet is arranged farther from the other ferrule than the first magnet.

9. The optical connector according to claim 7, wherein
the second magnet is arranged closer to the other ferrule than the first magnet.

10. The optical connector according to claim 1, wherein
the one ferrule has a guide hole, and
the other ferrule has a guide pin to be inserted into the guide hole.

11. The optical connector according to claim 1, wherein
the other ferrule has a guide hole, and
the one ferrule has a guide pin to be inserted into the guide hole.

12. The optical connector according to claim 1, wherein
the other ferrule is pressed by a pressing member toward the one ferrule.

13. The optical connector according to claim 6, further comprising a pressing member that presses the one ferrule toward the other ferrule.

14. The optical connector according to claim 6, wherein
the one ferrule has a guide hole, and
the other ferrule has a guide pin to be inserted into the guide hole.

15. The optical connector according to claim 6, wherein
the other ferrule has a guide hole, and
the one ferrule has a guide pin to be inserted into the guide hole.

16. The optical connector according to claim 6, wherein
the other ferrule is pressed by a pressing member toward the one ferrule.
